(19) United States
(12) Patent Application Publication
(10) Pub. No.: US 2008/0080571 A1
(43) Pub. Date: Apr. 3, 2008

(54) INTRACAVITY FREQUENCY-DOUBLING LASER DEVICE

(76) Inventors: Yingjun Ma, Fujian (CN); Jiwu Ling, Fujian (CN); Li Wu, Fujian (CN); Youyi Huang, Fujian (CN); Kangiun Wang, Fujian (CN)

Correspondence Address: XIN WEN, 3449 RAMBOW DRIVE, PALO ALTO, CA, 94306, US

(21) Appl. No.: 11/622,387

(22) Filed: Jan. 11, 2007

(30) Foreign Application Priority Data
Oct. 3, 2006 (CN) 200610039623.5

(51) Int. Cl. H01S 3/10

(52) U.S. Cl. 372/22

(57) ABSTRACT

An intra-cavity frequency-doubling laser device includes a first mirror and a second mirror defining a resonance cavity therein, a gain media to produce a first lasing light in response to an excitation energy received from outside of the resonance cavity, a non-linear optical material to generate a second lasing light in response to the first lasing light. The second lasing light and the first lasing light have different frequencies. The first mirror is reflective to the first lasing light and the second lasing light. The second mirror is reflective to the first lasing light and at least partially transmissive to the second lasing light. A birefringent optical material in the resonance cavity can rotate the polarization direction of at least one of the first lasing light and the second lasing light. An optical axis of the birefringent optical material and an optical axis of the non-linear optical material have an angle between 30 and 60 degrees.

### CROSS-REFERENCES TO RELATED INVENTIONS

The present invention claims priority to commonly assigned Chinese Patent Application No. 200610039623.5 filed on Oct. 3, 2006, titled “An intra-cavity frequency doubling laser device”. The disclosures of these related applications are incorporated herein by reference.

### BACKGROUND

The present disclosure relates to laser technologies, in particular, intra-cavity non-linear laser devices.

Laser devices are widely used in measurement, communications, laser pointers, and displays. In many of these applications, it is desirable for the laser devices to have consistent performance over a wide temperature range. A conventional laser device 100, shown in FIG. 1, can include a gain media 1 that includes a mirror 11, and a non-linear optical material 2 that includes a mirror 12. The gain media 1 can be a Nd:YVO₄ crystal. The non-linear optical material 2 can be a KTP crystal. The optical axes of the gain media 1 and the non-linear optical material 2 are typically aligned at 45 degrees relative to each other. A pump light 20 at 808 nm is illuminated at the mirror 11. The mirror 11 is highly transmissive to the pump light 20 at 808 nm. The energy of the pump light 20 is directed through the gain media 1 to produce a first lasing light 21 at 1064 nm. A second lasing light 22 at 532 nm is created in non-linear optical material 2 as after first lasing light 21 enters the non-linear optical material 2. The mirror 11 is highly reflective at wavelengths at 532 nm and 1064 nm. The mirror 12 is highly reflective at 1064 nm but is transmissive at 532 nm. The first lasing light 21 is thus reflected back and forth by the mirrors 11 and 12 in multiple passes and confined in the gain media 1 and the non-linear optical material 2. The second lasing light 22 can exit the mirror 12 to form an output laser beam 25 at 532 nm.

One drawback of the conventional laser device 100 is that the power of the output light 25 can significantly vary as a function of temperature. FIG. 2 illustrates exemplified power-temperature dependence of the output laser beam 25 by the conventional laser device 100. The power of the output laser beam 25 can have large variations as a function of temperature. The conventional laser device 100 needs to operate in a constrained temperature range in order to provide a stable power output.

### SUMMARY

In a general aspect, the present invention relates to an intra-cavity frequency-doubling laser device including a first mirror and a second mirror defining a resonance cavity therein; a gain media in the resonance cavity, wherein the gain media is configured to produce a first lasing light in response to an excitation energy received from outside of the resonance cavity; a non-linear optical material in the resonance cavity, wherein the non-linear optical material is configured to generate a second lasing light in response to the first lasing light, wherein the second lasing light and the first lasing light have different frequencies, wherein the first mirror is reflective to the first lasing light and the second lasing light, and wherein the second mirror is reflective to the first lasing light and at least partially transmissive to the second lasing light; and a birefringent optical material in the resonance cavity, wherein the birefringent optical material is configured to rotate the polarization direction of at least one of the first lasing light and the second lasing light, and wherein an optical axis of the birefringent optical material and an optical axis of the non-linear optical material have an angle between 30 and 60 degrees.

In another general aspect, the present invention relates to an intra-cavity frequency-doubling laser device including a first mirror and a second mirror defining a resonance cavity therein; a gain media in the resonance cavity, wherein the gain media is configured to produce a first lasing light in response to an excitation energy received from outside of the resonance cavity; a non-linear optical material in the resonance cavity, wherein the non-linear optical material is configured to generate a second lasing light in response to the first lasing light, wherein the first lasing light and the second lasing light have different frequencies, wherein the first mirror is reflective to the first lasing light and the second lasing light, and wherein the second mirror is reflective to the first lasing light and at least partially transmissive to the second lasing light; and a birefringent optical material in the resonance cavity, wherein the birefringent optical material is a half waveplate, a quarter waveplate, or a ⅛ waveplate of the first lasing light and a quarter waveplate, a half waveplate, or a whole waveplate of the second lasing light, wherein an optical axis of the birefringent optical material and an optical axis of the non-linear optical material have an angle between 30 and 60 degrees, and wherein the gain media has an optical axis that is approximately orthogonal or parallel to the optical axis of the non-linear optical material.

In another general aspect, the present invention relates to an intra-cavity frequency-doubling laser device including a first mirror and a second mirror defining a resonance cavity therein; a gain media in the resonance cavity, wherein the gain media is configured to produce a first lasing light in response to an excitation energy received from outside of the resonance cavity; a non-linear optical material in the resonance cavity, wherein the non-linear optical material is configured to generate a second lasing light in response to the first lasing light, wherein the first lasing light and the second lasing light have different frequencies, wherein the first mirror is reflective to the first lasing light and the second lasing light, wherein the second mirror is reflective to the first lasing light and at least partially transmissive to the second lasing light, and wherein an optical axis of the gain media and an optical axis of the non-linear optical material are aligned at an angle between 30 and 60 degrees relative to each other; and a birefringent optical material in the resonance cavity, wherein the birefringent optical material is configured to rotate the polarization of at least one of the first lasing light and the second lasing light, wherein the birefringent optical material has an optical axis substantially parallel to the optical axis of the gain media or the non-linear optical material and substantially perpendicular to propagation direction of the first lasing light or the second lasing light, and wherein at least two of the birefringent optical material, the gain media, and the non-linear optical material are held in contact in the resonance cavity.

Implementations of the systems may include one or more of the following. The optical axis of the birefringent optical material and the optical axis of the non-liner optical material can have an angle about 45 degrees. The gain media can have an optical axis that is approximately orthogonal to the optical axis of the non-linear optical material. The gain media can have an optical axis that is approximately parallel to the optical axis of the non-linear optical material. The intra-cavity frequency-doubling laser device can further include a pump source configured to produce a pump light that is configured to pass through the first mirror to provide the excitation energy to the gain media. The pump source can include a laser diode. The propagation directions of the first lasing light and the second lasing light can be substantially parallel to each other. The optical axes of the birefringent optical material and the non-linear optical material can be substantially perpendicular to the propagation direction of the first lasing light or the second lasing light. The gain media can include at least one selected from the group consisting of Nd:YVO₄, ND:YLF, Nd:YAG, and Nd:GdV_{O4}. The non-linear optical material can include at least one selected from the group consisting of KTP, LBO, BBO, KNbO₃, and LiNBO₃. The birefringent optical material can include quartz. At least one of the first mirror and the second mirror includes a coating on a surface of the birefringent optical material, the gain media, or the non-linear optical material. At least two of the birefringent optical material, the gain media, and the non-linear optical material are held in contact with each other. At least two of the birefringent optical material, the gain media, and the non-linear optical material can be in contact at an interface, wherein the interface comprises an optical film configured to enhance the transmissions of the first lasing light, or the second lasing light, or a combination thereof. The birefringent optical material and the gain media can be formed in a unitary component that is configured to produce a first lasing light in response to an excitation energy received from outside of the resonance cavity and to rotate the polarization direction of at least one of the first lasing light and the second lasing light, and wherein an optical axis of the unitary component and the optical axis of the non-linear optical material have an angle between 30 and 60 degrees. The birefringent optical material, the gain media, and the non-linear optical material can be sequentially positioned from the first mirror to the second mirror. The gain media, the birefringent optical material, and the non-linear optical material can be sequentially positioned from the first mirror to the second mirror. The non-linear optical material, the gain media, and the birefringent optical material can be sequentially positioned from the first mirror to the second mirror. The gain media, the non-linear optical material, and the birefringent optical material can be sequentially positioned from the first mirror to the second mirror. The birefringent optical material, the non-linear optical material, and the gain media can be sequentially positioned from the first mirror to the second mirror. The non-linear optical material, the birefringent optical material, and the gain media can be sequentially positioned from the first mirror to the second mirror. The birefringent optical material can be a half waveplate, a quarter waveplate or a ⅛ waveplate of the first lasing light. The birefringent optical material can be a quarter waveplate, a half waveplate, or a whole waveplate of the second lasing light. The second lasing light can have a frequency substantially two times a frequency of the first lasing light.

Embodiments may include one or more of the following advantages. The disclosed laser device and methods can significantly improve the power stability of the output laser beam over temperature, which overcomes a major drawback in the convention laser devices. The disclosed laser devices are therefore suitable for a wider range of applications than the conventional laser device. The disclosed laser device can be used indoors, out doors, and in a wide range of weather and climate conditions. Furthermore, the disclosed laser device can provide output laser beams having lower noise, higher polarization ratio, and higher power compared to some conventional laser devices.

Although the invention has been particularly shown and described with reference to multiple embodiment, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a schematic diagram of a conventional laser device.

FIG. 2 illustrates exemplified power-temperature dependence of the output laser by the conventional laser device.

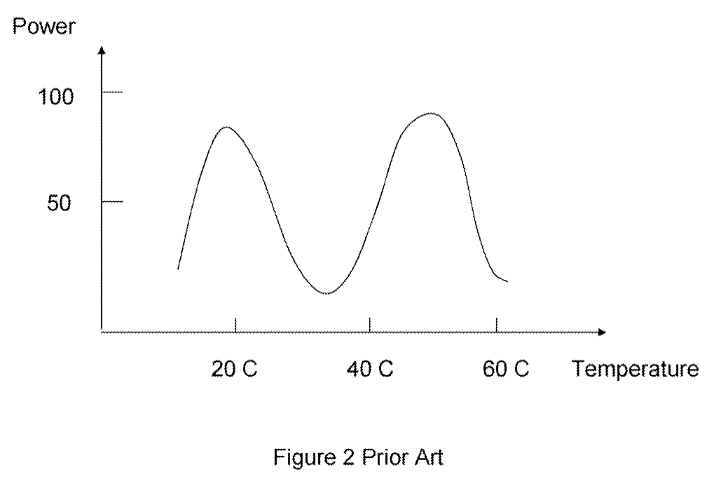

FIG. 3 is a schematic diagram of an exemplified laser device in accordance with the present disclosure.

FIG. 4A illustrates exemplified orientations of optical axes of the birefringent optical material, and the non-linear optical material in the laser device of FIG. 3.

FIG. 4B illustrates exemplified polarizations of the first lasing light and the second lasing light, and the optical axes for the gain media, the birefringent optical material, and the non-linear optical material. The exemplified birefringent optical material is a quarter wavelength waveplate for the second lasing light.

FIG. 4C illustrates another example of the polarization directions of the first lasing light the second lasing light, and the optical axes for the gain media, the birefringent optical material, and the non-linear optical material. The exemplified birefringent optical material is a quarter wavelength waveplate for the second lasing light.

FIG. 5A is a schematic diagram of another exemplified laser device in accordance with the present disclosure.

FIG. 5B illustrates exemplified orientations for optical axes of the gain media and the non-linear optical material in the laser device of FIG. 5A.

FIG. 6 is a schematic diagram of another exemplified laser device in accordance with the present disclosure.

FIG. 7 is a schematic diagram of another exemplified laser device in accordance with the present disclosure.

FIG. 8A is a schematic diagram of another exemplified laser device in accordance with the present disclosure.

FIG. 8B illustrates exemplified orientations for optical axes of the gain media and the non-linear optical material in the laser device of FIG. 8A.

### DETAILED DESCRIPTION

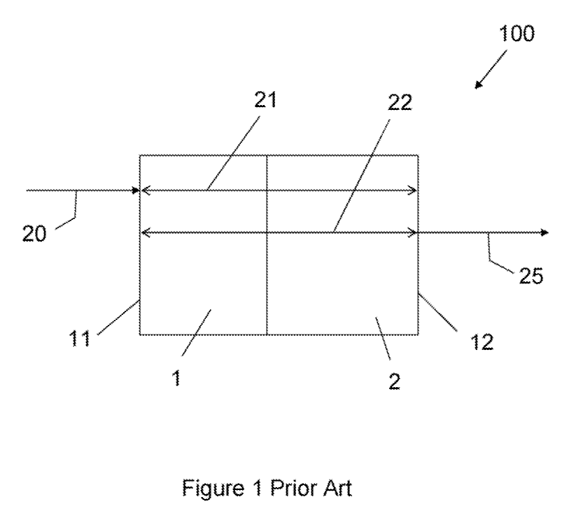

The disclosed laser devices and operating methods are developed to overcome the drawback in the convention laser devices. The mechanism of the temperature dependence of the output laser beam was investigated. Referring to FIG. 1, it was found that the temperature dependence in the output power was caused by the interference between the second lasing light 22 in different passes in the non-linear optical material and the non-linear coupling between the first lasing light 21 and the second lasing light 22 in the non-linear optical material. The second lasing light 22 is first generated by the non-liner optical material 2 after the first lasing light 21 enters the non-linear optical material 2 in the first pass. It was found that a portion of the second lasing light 22 is reflected by the mirror 12 even if the second lasing light 22 can exit the mirror 12 to produce a portion of the output laser beam 25. The second lasing light 22 reflected by the mirror 12 travels back and enters the gain media 1. The second lasing light 22 in the gain media 1 is reflected by the mirror 11 and re-enters the non-linear optical material 2 in a second pass. Similarly, the first lasing light 21 in the first pass in the non-linear optical material 2 is reflected by the mirror 12, re-enters the gain media 1, reflected by the mirror 11, and re-enters the non-linear optical material 2 in a second pass.

The first lasing light 21 and the second lasing light 22 in the second pass can have a phase differences from the phases of their counterparts in the first pass. The phase difference exists because the gain media 1 can act effectively as a waveplate to the first lasing light 21 and the second lasing light 22. The amount of phase shifts is dependent on the optical distance of the gain media 1. The optical distance in the gain media 1 is proportional to the thickness of the gain media, which can vary as a function of temperature. Modeling of the non-linear coupling between the first lasing light 21 and the second lasing light 22 in the different passes in the non-linear optical material 2 shows that the power of at least a portion of the output laser beam 25 is proportional to cos(Δφ/2)², wherein the phase difference Δφ is related to the optical length of the gain media 1, which can be sensitive to temperature variations. The output power can thus vary in a range between 0 and 1 depending on the phase difference Δφ.

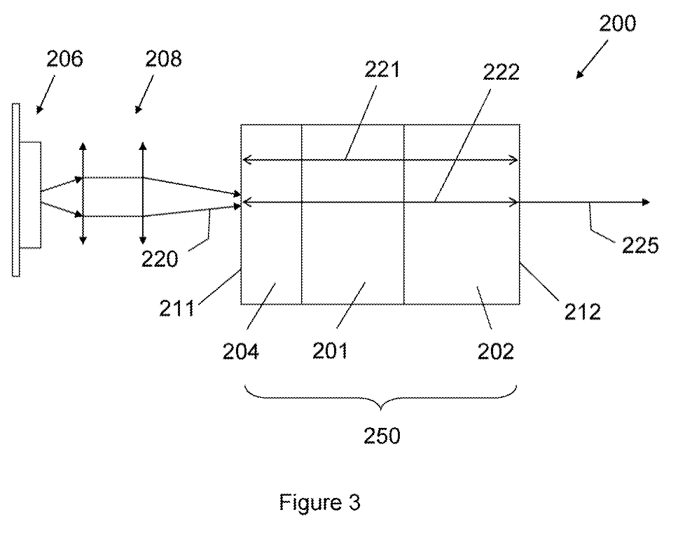

A laser device 200, shown in FIG. 3, can include a birefringent optical material 204 having a mirror 211, a gain media 201, and a non-linear optical material 202 having an output mirror 212. A pump light 220 is emitted by a laser diode 206 and directed to the input mirror 211 by an optical system 208. The mirror 211 is highly transmissive at the wavelength of the pump light 220. The mirror 211 can be provided by a coating on the outer surface of the birefringent optical material 204. The pump light 220 passes the birefringent optical material 204 and the gain media 201. The pump light 220 can provide excitation energy to the gain media 201 that can produce a first lasing light 221 at a base frequency. A second lasing light 222 is created in non-linear optical material 202 as after first lasing light 221 enters the non-linear optical material 202. The mirror 211 is highly reflective to both the first lasing light 221 and the second lasing light 222. The mirror 212 is highly reflective to the first lasing light 221 and is at least partially transmissive to the second lasing light 222. The mirror 212 can be provided by a coating on the outer surface of the non-linear optical material 202. The first lasing light 221 is thus reflected back and forth by the mirrors 211 and 212 in multiple passes and is confined between the mirrors 211 and 212. The second lasing light 222 can transmit out of the mirror 212 to form an output laser beam 225.

The mirrors 211 and 212 act as mirrors to the first lasing light 221 and define a resonance cavity 250 for the first lasing light 221. The second lasing light 222 has a frequency different from the frequency of the first lasing light 221. For example, the second lasing light 222 can have a frequency that is a multiple of the frequency of the first lasing light 221. Specifically, the second lasing light 222 can have a frequency two times of the frequency of the first lasing light 221. The frequency doubling by the non-linear optical material 202 occurs within the resonance cavity 250. The laser device 20 can be referred to as an intra-cavity frequency-doubling laser device.

Materials suitable for the gain media 201 include but are not limited to Nd:YVO₄, Nd:YLF, Nd:YAG, Nd:GdVO₄, etc. Materials suitable for the nonlinear material 202 include but are not limited to: KTP, LBO, BBO, KNbO₃, LiNBO₃, etc. The birefringent optical material 204 can for example be made of quartz. The birefringent optical material 204 can be a waveplate for the first lasing light and/or the second lasing light. For example, the wavelength of the pump light 220 can be at 808 nm. The wavelength of the first lasing light 221 can be at about 1064 nm. The second lasing light 222 and the output laser beam 225 of the first lasing light 221 can have frequencies at about twice the frequency of the first lasing light. For example, the wavelengths for second lasing light 222 and the output laser beam 225 of the first lasing light 221 can be at about 532 nm.

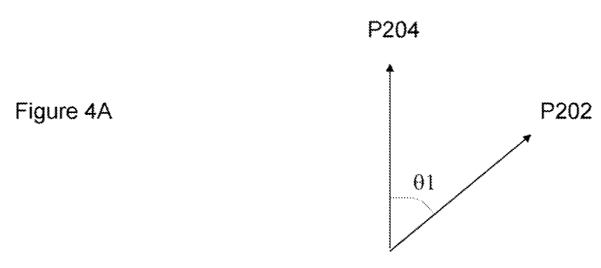

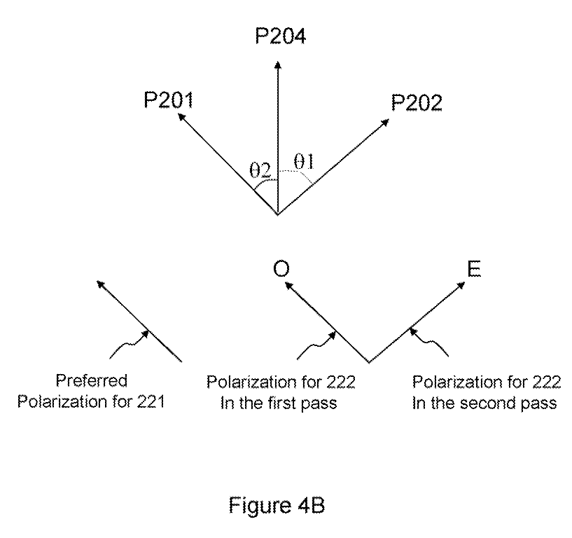

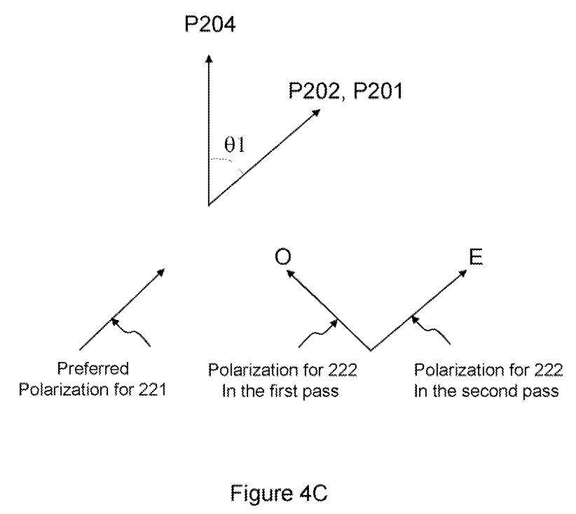

In some embodiments, the birefringent optical material 204, the gain media 201, and the non-linear optical material 202 can be sequentially positioned and with each pairs of neighboring components in contact with each other. For example, as shown in FIG. 3, the the birefringent optical material 204 and the gain media 201 can be joined optical glue. The gain media 201 and the non-linear optical material 202 can also be held together by optical glue. The positional sequence of the birefringent optical material 204, the gain media 201, and the non-linear optical material 202 can be different as described below in relation with FIGS. 4A-8B. In some embodiments, the birefringent optical material 204, the gain media 201, and the non-linear optical material 202 can be sequentially positioned without in contact with each other. The interface at the pair of the birefringent optical material 204, the gain media 201, and the non-linear optical material 202 that are in contact with each other can optical film configured to enhance the transmissions of the first lasing light, or the second lasing light, or a combination thereof. The optical film can be coated on one or both of the components that are in contact. The optical film can produce appropriate interference in the first lasing light and/or the second lasing light to enhance their transmissions through the birefringent optical material 204, the gain media 201, and the non-linear optical material 202.

The mirrors 211 and 212 can be coated on the surfaces of the birefringent optical material 204, the gain media 201, and the non-linear optical material 202 that define the input end and the output end of the resonance cavity 250. The mirrors 211 and 212 can also be stand alone components that may or may not be in contact with the birefringent optical material 204, the gain media 201, and the non-linear optical material 202.

The birefringent optical material 204 and the gain media 201 are birefringent materials. The relative orientations of optical axis P204 for the birefringent optical material 204 and optical axis P202 for the non-linear optical material 202 are shown in FIG. 4A. The first lasing light 221 and the second lasing light 222 can propagate substantially parallel to each other. The optical axes P201, P202, and P204 can be substantially perpendicular to the propagation directions of the first lasing light 221 and the second lasing light 222. The angle θ1 between P204 and P202 can be in the range of 30 to 60 degrees, or between 40 and 50 degrees. For example, the birefringent optical material 204 and the optical axis P202 can be aligned such that the angle θ1 is about 45 degrees. The optical axis of the gain media 201 can be positioned orthogonal or parallel to the optical axis P202 for the non-linear optical material 202.

In some embodiments, referring to FIG. 4B, the optical axis P201 of the gain media 201 can be positioned orthogonal to the optical axis P202 for the non-linear optical material 202. The angle θ2 between P204 and P201 can thus also be in the range of 30 to 60 degrees, or between 40 and 50 degrees, such as 45 degrees. The birefringent optical material 204 is a quarter waveplate (i.e. a wave plate that retards polarization of the light by ¼ of the wavelength λ) at the wavelength of the second lasing light 222. A wave plate refers to a birefringent material (e.g. crystal) with a carefully chosen thickness between an input surface and an output surface. A light beam can pass through the input and the output surface. The birefringent crystal is cut so that the optical axis (i.e. the principle axis of anisotropy) of the birefringent crystal is parallel to the input and output surfaces. The birefringent properties of the gain media 201 can produce a preferred polarization of the first lasing light 221 along the optical axis P201. In one implementation, the non-linear optical material 202 satisfies the II Class phase matching conditions between the first lasing light 221 (base frequency) and the second lasing light 222. The second lasing light 222 created in the first pass can thus be an ordinary (O) ray in the non-linear optical material 202. In other words, as shown in FIG. 4B, the polarization of the second lasing light 222 in the first pass is perpendicular to the optical axis P202 of the non-linear optical material 202, and parallel to P201 and the preferred polarization direction of the first lasing light 221. A portion of the second lasing light 222 is reflected by the mirror 212, passes through the gain media 221 and the birefringent optical material 204, and subsequently reflected by the mirror 211. In the return path, the second lasing light 222 passes through the gain media 201 and enters the non-linear optical material 202 in a second pass. Since the birefringent optical material 204 is a quarter waveplate for the second lasing light 222, the polarization of the second lasing light 222 is rotated 90 degrees in the second pass relative to the polarization of the second lasing light 222 in the first pass. The polarization of the second lasing light 222 in the second pass is thus an extraordinary (E) ray in the non-linear optical material 202, which is parallel to the optical axis P202 and perpendicular to the polarization of the first lasing light 221, as shown in FIG. 4B. Since the polarization of the second lasing light 222 in the second pass is orthogonal to the polarization of the second lasing light 222 in the first pass the second lasing light 222 in the first and second passes cannot interfere with each other. In the non-linear optical material 202, the first lasing light 221 is not non-linearly coupled to the second lasing light 222 in the second pass. The output laser beam 225 in the laser device 200 is therefore not dependent on a phase difference φ (via a function of cos(Δφ/2)²) as in some conventional laser devices (such as the laser device 100 described above). The de-coupling between the output laser beam 225 and the second lasing light 222 in the second pass can eliminate or significantly reduce the temperature dependence in the output laser beam 225.

Similarly, referring to FIG. 4C, the optical axis P201 of the gain media 201 can be aligned parallel to the optical axis P202 for the non-linear optical material 202. The preferred polarization direction of the first lasing light 221 in the gain media 201 can be along the P201 direction. The birefringent optical material 204 is a quarter waveplate at the wavelength of the second lasing light 222. The non-linear optical material 202 can satisfy the II Class phase matching conditions between the first lasing light 221 (base frequency) and the second lasing light 222. The second lasing light 222 created in the first pass is thus an ordinary (O) ray in the non-linear optical material 202. The second lasing light 222 in the second pass is an extraordinary (E) ray in the non-linear optical material 202 after a 90 degree rotation by the birefringent optical material 204. The polarization of the second lasing light 222 in the second pass is therefore orthogonal to the polarization of the second lasing light 222 in the first pass; the second lasing light 222 in the two passes cannot interfere with each other. The non-linear coupling with first lasing light is also suppressed. The output laser beam 225 will not significantly vary as a function of temperature dependent phase shift as in some conventional laser devices.

In some embodiments, the birefringent optical material 204 and the gain media 201 can be provided as a single unitary component. The unitary component can be a quarter waveplate at the wavelength of the second lasing light 222, which performs functions as described above. The unitary component can produce the first lasing light in response to an excitation energy received from outside of the resonance cavity. The unitary component can rotate the polarization direction of at least one of the first lasing light and the second lasing light. The optical axis of the unitary component and the optical axis of the non-linear optical material have an angle between 30 and 60 degrees, or between 40 and 50 degrees, such as 45 degrees. Other configurations of a laser device is also disclosed in the commonly assigned U.S. patent application Ser. No. 10/928,890, entitled “Low noise, intra-cavity frequency-doubling micro chip laser with wide temperature range”, filed Aug. 27, 2004, the disclosure of which is incorporated herein by reference.

In some embodiments, the birefringent optical material 204 can be selected to be waveplates for the first lasing light 221 and/or the second lasing light 222. For example, the birefringent optical material 204 can be selected to be a quarter waveplate for the first lasing light 221 to produce orthogonal polarizations between the first lasing light 221 in successive passes, which is found to reduce noise in the output laser beam 225. In another example, the birefringent optical material 204 can be selected to be a ⅛ waveplate (i.e. a waveplate that retards polarization of the light by ⅛ of the wavelength λ) for the first lasing light 221 to produce circularly polarization in the first lasing light 221. The circularly polarized first lasing light 221 can produce substantially equal amplitudes in the “O” ray and the “E” ray in the non-linear optical material 202, which can maximize the power of the output laser beam 225. Moreover, the birefringent optical material 204 can be selected to be a half waveplate (i.e. a waveplate that retards polarization of the light by ½ the wavelength λ) for the first lasing light 221.

In another example, the birefringent optical material 204 can be selected to be a quarter waveplate for the second lasing light 222, as described above, to achieve stable output laser beam 225 over a wide temperature range. In yet another example, the birefringent optical material 204 can be selected to be a half waveplate or a whole (i.e. a wave plate that retards polarization of the light by a full wavelength λ) waveplate for the second lasing light 222 to enhance the polarization of the second lasing light 222 in different passes along a linear direction, which can finally produce high polarization ratio in the output laser beam 225.

The birefringent optical material 204 can be a “double waveplate” that has simultaneously different waveplate properties for the first lasing light 221 and the second lasing light 222. For example, the birefringent optical material 204 can be a half waveplate or a whole waveplate for the second lasing light 222 and also be a quarter waveplate for the first lasing light 221 to reduce noise and achieve high polarization ratio in the output laser beam 225. In another example, the birefringent optical material 204 can be a quarter waveplate for the second lasing light 222 and a ⅛ waveplate for the first lasing light 221 to maximize power in the output laser beam 225 in a wide temperature range.

It should be noted that the waveplate for the first lasing light and the second lasing light are specified by the amount of retardations in the polarization the waveplates can produce at the respective wavelengths of the first lasing light and the second lasing light. For example, the amount of the retardation in the polarization can be substantially ⅛, ¼, ½ and 1 times of a wavelength of the first or the second lasing light. The amount of retardation can include additional integer number of wavelengths without affecting the performance. The precisions of the respective waveplates in the amounts of the polarization retardations can be controlled within about 10% of a wavelength, within about 5% of a wavelength, within about 1% of a wavelength, or within about 0.5% of a wavelength.

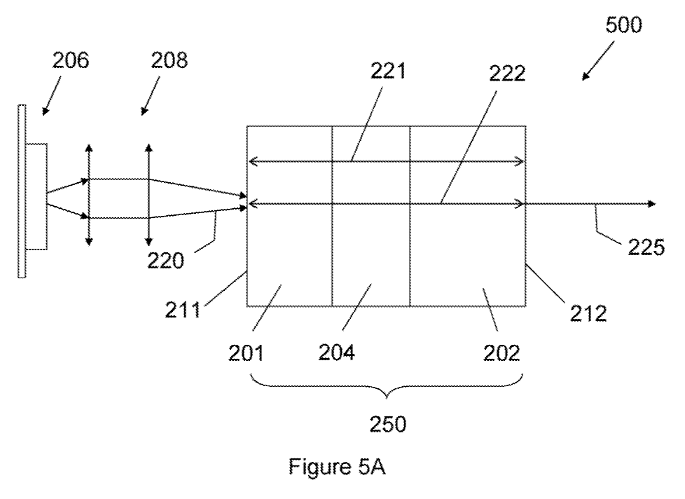

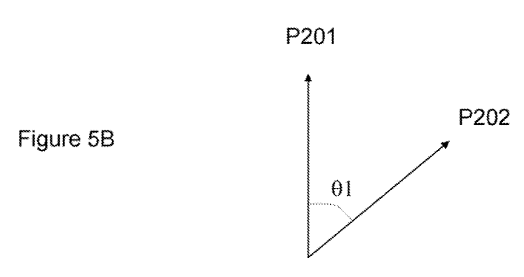

FIG. 5A is a schematic diagram of another exemplified laser device 500 in accordance with the present disclosure. The laser device 500 is similar to the laser device 200 except for that the relative positions of the birefringent optical material 204 and the gain media 201 are switched. The optical axes of the gain media 201, the birefringent optical material 204, and the non-linear optical material 202 can be positioned as shown in FIG. 4A. The birefringent optical material 204 can be selected to be a quarter waveplate for the first lasing light 221 to reduce noise in the output laser beam 225. The birefringent optical material 204 can also be selected to be a quarter waveplate for the second lasing light 222 to achieve stable output laser beam 225 over a wide temperature range. The birefringent optical material 204 can be selected to be a double waveplate that is a quarter waveplate for the first lasing light 221 and a quarter waveplate for the second lasing light 222 to reduce noise in the output laser beam 225 and provide stable performance over a wide temperature range. The birefringent optical material 204 can also be selected to be a half waveplate for the first lasing light 221.

In another implementation, referring to FIGS. 5A and 5B, the optical axes P201 and 202 are at 30 to 60 degrees, or between 40 and 50 degrees, such as about 45 degree relative to each other. The optical axis P202 satisfies the II Class phase matching conditions for frequency doubling of the first lasing light 221. In one implementation, the optical axis P204 can be parallel to the optical axes P201. The birefringent optical material 204 and the gain media 201 can be held together to form a quarter waveplate of the second lasing light 222. In another implementation, the optical axis P204 can also be parallel to the optical axes P202. The gain media 201 is selected to be a quarter waveplate for the second lasing light 222.

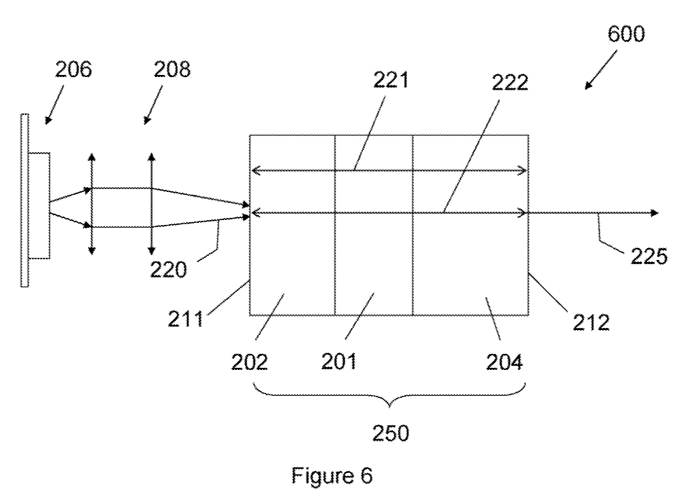

FIG. 6 is a schematic diagram of another exemplified laser device 600 in accordance with the present disclosure. The laser device 600 is similar to the laser device 200 except for that the positions of the non-linear optical material 202, the gain media 201, and the birefringent optical material 204. The non-linear optical material 202, the gain media 201, and the birefringent optical material 204 are sequentially positioned from the input mirror 211 to the output mirror 212. The optical axes of the gain media 201, the birefringent optical material 204, and the non-linear optical material 202 can be positioned as shown in FIG. 4A. The birefringent optical material 204 can be selected to be a quarter waveplate for the first lasing light 221 to reduce noise in the output laser beam 225 or a ⅛ waveplate for the first lasing light 221 to maximize power in the output laser beam 225. The birefringent optical material 204 can also be selected to be a half waveplate or a whole waveplate for the second lasing light 222 to achieve high polarization ratio in the output laser beam 225. The birefringent optical material 204 can be a double waveplate that is a quarter waveplate or a λ/8 waveplate for the first lasing light 221 as well as a half waveplate or a whole waveplate for the second lasing light 222. In other embodiments, the non-linear optical material 202, the birefringent optical material 204 and the gain media 201 can also be sequentially positioned from the input mirror 211 to the output mirror 212.

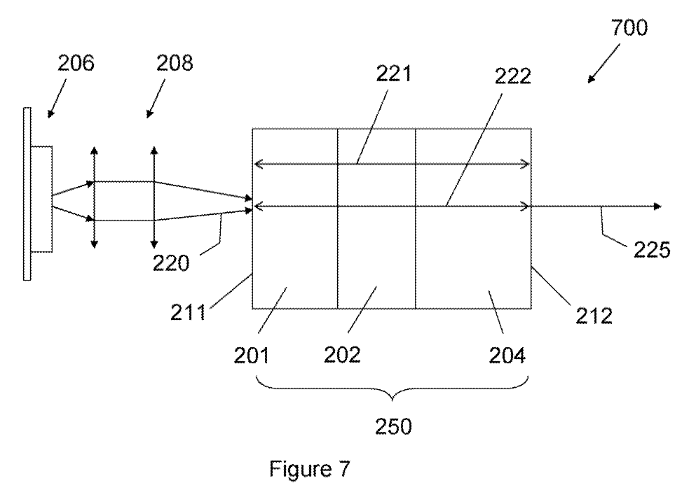

FIG. 7 is a schematic diagram of another exemplified laser device 700 in accordance with the present disclosure. The laser device 700 is similar to the laser device 200 except for that the positions of the gain media 201, the non-linear optical material 202, and the birefringent optical material 204. The gain media 201, the non-linear optical material 202, and the birefringent optical material 204 are sequentially positioned from the input mirror 211 to the output mirror 212. The optical axes of the gain media 201, the birefringent optical material 204, and the non-linear optical material 202 can be positioned as shown in FIG. 4A. The birefringent optical material 204 can be selected to be a quarter waveplate for the first lasing light 221 to reduce noise in the output laser beam 225 or a ⅛ waveplate for the first lasing light 221 to maximize power in the output laser beam 225. The birefringent optical material 204 can also be selected to be a half waveplate or a whole waveplate for the second lasing light 222 to achieve high polarization ratio in the output laser beam 225. The birefringent optical material 204 can be a double waveplate that is a quarter waveplate or a ⅛ waveplate for the first lasing light 221 as well as a half waveplate or a whole waveplate for the second lasing light 222.

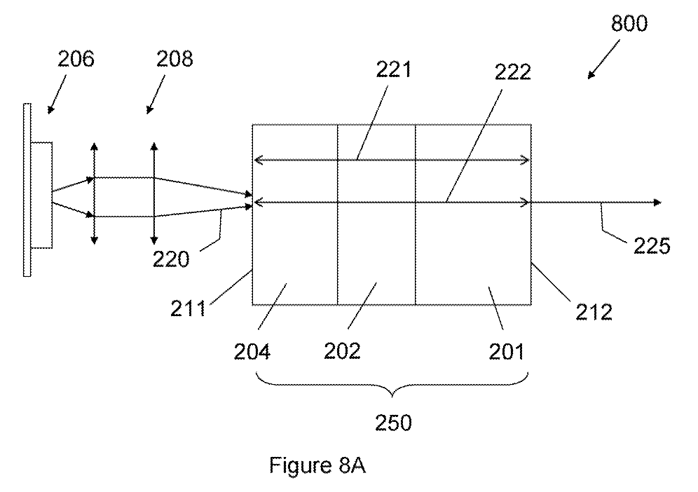

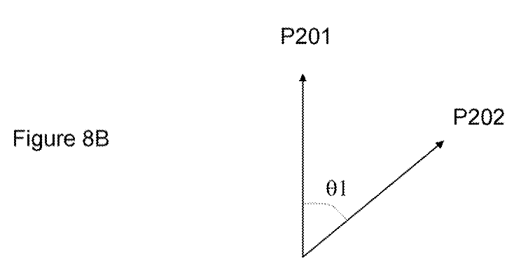

FIG. 8A is a schematic diagram of another exemplified laser device 800 in accordance with the present disclosure. The laser device 800 is similar to the laser device 200 except for that the positions of the birefringent optical material 204, the non-linear optical material 202, and the gain media 201. The birefringent optical material 204, the non-linear optical material 202, and the gain media 201 are sequentially positioned from the input mirror 211 to the output mirror 212. The optical axes of the gain media 201, the birefringent optical material 204, and the non-linear optical material 202 can be positioned as shown in FIG. 4A. The birefringent optical material 204 can be selected to be a quarter waveplate for the first lasing light 221 to reduce noise in the output laser beam 225 or a ⅛ waveplate for the first lasing light 221 to maximize power in the output laser beam 225. The birefringent optical material 204 can be selected to be a half or a whole waveplate for the second lasing light 222 to achieve high polarization ratio in the output laser beam 225. The birefringent optical material 204 can also be selected to be a quarter waveplate of the second lasing light 222 to provide stable power output in the output laser beam. The birefringent optical material 204 can be a double waveplate that can simultaneously perform as waveplates for the first lasing light 221 and the second lasing light 222.

In another implementation, referring to FIGS. 8A and 8B, the optical axes P201 and 202 are at 30 to 60 degrees, or between 40 and 50 degrees, such as about 45 degree relative to each other. The optical axis P202 satisfies the II Class phase matching conditions for frequency doubling of the first lasing light 221. The optical axis P204 can be parallel to the optical axes P201 or the optical axis P202. The birefringent optical material 204 is selected to be a quarter waveplate for the second lasing light 222.

The disclosed laser device and methods can include one or more of the following advantages. The disclosed laser device and methods can significantly improve the power stability of the output laser beam over temperature, which overcomes a major drawback in the convention laser devices. The disclosed laser devices are therefore suitable for a wider range of applications than the conventional laser device. The disclosed laser device can be used indoors, out doors, and in a wide range of weather and climate conditions. Furthermore, the disclosed laser device can provide output laser beams having lower noise, higher polarization ratio, and higher power than the conventional laser devices.

It should be understood that the disclosed laser devices and methods are not limited to the specific materials and configurations described above. For example, the first lasing light of the base frequency can include polarizations that are not parallel to the optical axis of the gain media. The optical axes of the gain media, the non-linear optical material, and the birefringent optical material can be not exactly parallel to the propagation direction of the first lasing light or the frequency doubled light. The mirrors that define the resonance cavity can be coatings on the surfaces of an optical components as described above, or standalone components. The gain media, the non-linear optical material, and the birefringent optical material in the resonance cavity can be positioned in different sequences other than the ones disclosed above.

1-30. (canceled)

31. An intra-cavity frequency-doubling laser device, comprising:
a first mirror and a second mirror defining a resonance cavity;
a gain media in the resonance cavity, wherein the gain media is configured to produce a first lasing light at a first wavelength;
a non-linear optical material in the resonance cavity, wherein the non-linear optical material is configured to generate a second lasing light at a second wavelength shorter than the at the first wavelength in response to the first lasing light; and
a birefringent material configured to produce a first polarization retardation in the first lasing light and a second polarization retardation in the second lasing light, wherein the first polarization retardation is about ⅛of the first wavelength.

32. The intra-cavity frequency-doubling of claim 31, wherein the first polarization retardation is smaller than the second polarization retardation.

33. The intra-cavity frequency-doubling of claim 31, wherein the first polarization retardation is within about 1% of the first wavelength around the ⅛of the first wavelength.

34. The intra-cavity frequency-doubling of claim 31, wherein the second polarization retardation is about ¼, about ½, or about one time of the second wavelength.

35. The intra-cavity frequency-doubling of claim 31, wherein an optical axis of the birefringent material is positioned between about 30 and about 60 degrees relative to an optical axis of the non-linear optical material.

36. The intra-cavity frequency-doubling of claim 35, wherein the optical axis of the birefringent material is positioned at about 45 degrees relative to the optical axis of the non-linear optical material.

37. The intra-cavity frequency-doubling laser device of claim 35, wherein an optical axis of the gain media is substantially orthogonal to the optical axis of the non-linear optical material.

38. The intra-cavity frequency-doubling laser device of claim 35, wherein an optical axis of the gain media is substantially parallel to the optical axis of the non-linear optical material.

39. The intra-cavity frequency-doubling of claim 31, wherein at least two of the birefringent material, the gain media, and the non-linear optical material are held in contact with each other.

40. The intra-cavity frequency-doubling of claim 31, wherein at least one of the first mirror and the second mirror is provided by a coating on a surface of the birefringent material, the gain media, or the non-linear optical material.

41. An intra-cavity frequency-doubling laser device, comprising:
a first mirror and a second mirror defining a resonance cavity;
a gain media in the resonance cavity, wherein the gain media is configured to produce a first lasing light at a first wavelength;
a non-linear optical material in the resonance cavity, wherein the non-linear optical material is configured to generate a second lasing light at a second wavelength shorter than the at the first wavelength in response to the first lasing light; and
a polarization-rotation device configured to produce a first polarization rotation in the first lasing light and a second polarization rotation in the second lasing light, wherein the second polarization rotation is smaller than the first polarization rotation.

42. The intra-cavity frequency-doubling of claim 41, wherein the polarization-rotation device is a birefringent material configured to produce a first polarization retardation in the first lasing light and a second polarization retardation in the second lasing light, wherein the second polarization retardation is smaller than the first polarization retardation.

43. The intra-cavity frequency-doubling of claim 42, wherein the first polarization retardation is about ¼, about ½, or about one time of the first wavelength.

44. The intra-cavity frequency-doubling of claim 42, wherein the second polarization retardation is about ⅛, about ¼, or about ½of the second wavelength.

45. The intra-cavity frequency-doubling of claim 42, wherein an optical axis of the birefringent material is positioned between about 30 and about 60 degrees relative to an optical axis of the non-linear optical material.

46. The intra-cavity frequency-doubling of claim 45, wherein the optical axis of the birefringent material is positioned at about 45 degrees relative to the optical axis of the non-linear optical material.

47. The intra-cavity frequency-doubling laser device of claim 41, wherein an optical axis of the gain media is substantially orthogonal to the optical axis of the non-linear optical material.

48. The intra-cavity frequency-doubling laser device of claim 41, wherein an optical axis of the gain media is substantially parallel to the optical axis of the non-linear optical material.

49. The intra-cavity frequency-doubling of claim 41, wherein at least two of the polarization-rotation device, the gain media, and the non-linear optical material are held in contact with each other.

50. The intra-cavity frequency-doubling of claim 41, wherein at least one of the first mirror and the second mirror is provided by a coating on a surface of the polarization-rotation device, the gain media, or the non-linear optical material.

51. The intra-cavity frequency-doubling of claim 41, wherein the second wavelength is about half the first wavelength.

52. An intra-cavity frequency-doubling laser device, comprising:
a first mirror and a second mirror defining a resonance cavity;
a gain media in the resonance cavity, wherein the gain media is configured to produce a first lasing light at a first wavelength;
a non-linear optical material in the resonance cavity, wherein the non-linear optical material is configured to generate a second lasing light at a second wavelength shorter than the at the first wavelength in response to the first lasing light; and
a polarization-rotation device configured to produce a first polarization rotation in the first lasing light and a second polarization rotation in the second lasing light, wherein the second polarization rotation is larger than the first polarization rotation.

53. The intra-cavity frequency-doubling of claim 52, wherein an optical axis of the gain media is positioned between about 30 and about 60 degrees relative to an optical axis of the non-linear optical material.

54. The intra-cavity frequency-doubling of claim 53, wherein the optical axis of the gain media is positioned at about 45 degrees relative to the optical axis of the non-linear optical material.

55. The intra-cavity frequency-doubling of claim 52, wherein the polarization-rotation device is a birefringent material configured to produce a first polarization retardation in the first lasing light and a second polarization retardation in the second lasing light, wherein the second polarization retardation is smaller than the first polarization retardation.

56. The intra-cavity frequency-doubling of claim 55, wherein an optical axis of the birefringent material is about parallel to the optical axis of the non-linear optical material or to the optical axis of the gain media.

57. The intra-cavity frequency-doubling of claim 55, wherein the first polarization retardation is about ⅛or about ¼of the first wavelength.

58. The intra-cavity frequency-doubling of claim 55, wherein the second polarization retardation is about ½or about one time of the second wavelength.

59. The intra-cavity frequency-doubling of claim 55, wherein the birefringent material and the gain media are held in contact with each other to form a waveplate for the second lasing light.

60. The intra-cavity frequency-doubling of claim 59, wherein the birefringent material and the gain media produce a polarization retardation of about ¼of the second wavelength in the second lasing light.

61. The intra-cavity frequency-doubling of claim 52, wherein at least two of the polarization-rotation device, the gain media, and the non-linear optical material are held in contact with each other.

62. The intra-cavity frequency-doubling of claim 52, wherein the polarization-rotation device and the gain media are positioned on the same side of the non-linear optical material in the resonance cavity.

63. The intra-cavity frequency-doubling of claim 52, wherein at least one of the first mirror and the second mirror is provided by a coating on a surface of the polarization-rotation device, the gain media, or the non-linear optical material.

64. An intra-cavity frequency-doubling laser device, comprising:
a first mirror and a second mirror defining a resonance cavity;
a gain media in the resonance cavity, wherein the gain media is configured to produce a first lasing light at a first wavelength;
a non-linear optical material in the resonance cavity, wherein the non-linear optical material is configured to generate a second lasing light at a second wavelength in response to the first lasing light, wherein the second wavelength is shorter than the first wavelength, wherein an optical axis of the gain media is positioned between about 30 and about 60 degrees relative to an optical axis of the non-linear optical material; and
a birefringent material held in contact with the gain media, wherein the birefringent material and the gain media in combination produce a polarization retardation of about ¼of the second wavelength in the second lasing light.

65. The intra-cavity frequency-doubling of claim 64, wherein the optical axis of the gain media is positioned at about 45 degrees relative to the optical axis of the non-linear optical material.

66. The intra-cavity frequency-doubling of claim 64, wherein an optical axis of the birefringent material is about parallel to the optical axis of the gain media.

67. The intra-cavity frequency-doubling of claim 64, wherein the birefringent material, the gain media, and the non-linear optical material are held in contact with each other to form a unitary optical component.

68. The intra-cavity frequency-doubling of claim 64, wherein the first mirror and the second mirror are formed respectively by coating on a surface of the birefringent material and the gain media that are held in contact, and a surface the non-linear optical material.
